(19) United States
(12) Patent Application Publication
(10) Pub. No.: US 2023/0409020 A1
(43) Pub. Date: Dec. 21, 2023

(54) DIGITAL TWIN SIMULATION DISCREPANCY DETECTION IN MULTI-MACHINE ENVIRONMENT

(71) Applicant: INTERNATIONAL BUSINESS MACHINES CORPORATION, ARMONK, NY (US)

(72) Inventors: Saraswathi Sailaja Perumalla, Visakhapatnam (IN); Sarbajit K. Rakshit, Kolkata (IN); Akash U. Dhoot, Pune (IN)

(21) Appl. No.: 17/806,755

(22) Filed: Jun. 14, 2022

(51) Int. Cl. G05B 19/418; G05B 23/02

(52) U.S. Cl. CPC G05B 19/41885; G05B 23/0283; G05B 19/4183

(57) ABSTRACT

An embodiment for detecting discrepancies in digital twin simulations in a multi-machine environment is provided. The embodiment may include receiving real-time and historical data from one or more sources in a multi-machine environment. The embodiment may also include creating a first digital twin model of a machine at a first time and a second digital twin model at a second time. The embodiment may further include identifying one or more environmental parameters. The embodiment may also include executing first and second digital twin simulations of a working procedure of the first and second digital twin models, respectively. The embodiment may further include identifying a discrepancy between the first and second digital twin models. The embodiment may also include in response to determining the discrepancy is caused by a foreign substance on a target area of the machine, prompting a robotic device to remove the foreign substance.

### BACKGROUND

The present invention relates generally to the field of computing, and more particularly to a system for detecting discrepancies in digital twin simulations in a multi-machine environment.

Machines, such as robots and factory equipment, are currently used to perform a wide variety of activities in an industrial environment. Some of these activities were previously exclusively performed by humans (e.g., repetitive tasks on a manufacturing assembly line), whereas other activities require heavy machinery to lift, move, and/or assemble objects. Machines enable organizations, including manufacturers and construction companies, to carry out a wide variety of activities more seamlessly than humans, getting work done faster and with minimum wasted effort. A digital twin simulation of the operations of these machines may be implemented based on feeds from various sensors in the multi-machine environment. The digital twin simulation may be used to determine whether any machine is running properly or malfunctioning.

### SUMMARY

According to one embodiment, a method, computer system, and computer program product for detecting discrepancies in digital twin simulations in a multi-machine environment is provided. The embodiment may include receiving real-time and historical data from one or more sources in a multi-machine environment. At least one source may be real-time feeds from a plurality of sensors in the multi-machine environment. The embodiment may also include creating a first digital twin model of a machine in the multi-machine environment at a first time based on the real-time feeds from the plurality of sensors at the first time. The embodiment may further include creating a second digital twin model of the machine in the multi-machine environment at a second time based on the real-time feeds from the plurality of sensors at the second time. The embodiment may also include identifying one or more environmental parameters present in the multi-machine environment at the first time and the second time based on the real-time and historical data from the one or more sources. The embodiment may further include executing a first digital twin simulation of a working procedure of the first digital twin model in accordance with the one or more environmental parameters and the real-time and historical data from the one or more sources at the first time. The embodiment may also include executing a second digital twin simulation of the working procedure of the second digital twin model in accordance with the one or more environmental parameters and the real-time and historical data from the one or more sources at the second time. The embodiment may further include identifying a discrepancy between the first digital twin model and the second digital twin model based on the execution of the first digital twin simulation and the second digital twin simulation. The embodiment may also include in response to determining the discrepancy is caused by a foreign substance on a target area of the machine, prompting a robotic device to remove the foreign substance from the target area of the machine.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIGS. 2A and 2B illustrate an operational flowchart for detecting discrepancies in digital twin simulations in a multi-machine environment in a digital twin discrepancy detection process according to at least one embodiment.

FIG. 3 is an exemplary diagram depicting a physical machine and digital twin models of the physical machine at different times according to at least one embodiment.

FIG. 4 is a functional block diagram of internal and external components of computers and servers depicted in FIG. 1 according to at least one embodiment.

FIG. 5 depicts a cloud computing environment according to an embodiment of the present invention.

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for detecting discrepancies in digital twin simulations in a multi-machine environment. The following described exemplary embodiments provide a system, method, and program product to, among other things, identify one or more discrepancies between a first digital twin model of a machine and a second digital twin model of the machine based on the execution of digital twin simulations and, accordingly, prompt a robotic device to remove a foreign substance from a target area of the machine. Therefore, the present embodiment has the capacity to improve industrial machine technology by identifying a reason behind a discrepancy between subsequent digital twin models such that the discrepancy may be automatically resolved.

As previously described, machines, such as robots and factory equipment, are currently used to perform a wide variety of activities in an industrial environment. Some of these activities were previously exclusively performed by humans (e.g., repetitive tasks on a manufacturing assembly line), whereas other activities require heavy machinery to lift, move, and/or assemble objects. Machines enable organizations, including manufacturers and construction companies, to carry out a wide variety of activities more seamlessly than humans, getting work done faster and with minimum wasted effort. A digital twin simulation of the operations of these machines may be implemented based on feeds from various sensors in the multi-machine environment. The digital twin simulation may be used to determine whether any machine is running properly or malfunctioning. When a machine is performing an activity, the machine may unexpectedly malfunction. This problem is typically addressed by implementing a digital twin of the physical machine and using feeds from sensors to monitor the condition of the physical machine. However, foreign substances may accumulate on one or more sensors positioned around the machine, and any digital twin models created based on covered sensors may be erroneous. For example, the sensors covered with the foreign substance may transmit incorrect data or no data at all.

It may therefore be imperative to have a system in place to determine whether any discrepancy between digital twin models is caused by a problem with the machine itself or due to an external factor (e.g., a foreign substance covering the sensors). Thus, embodiments of the present invention may provide advantages including, but not limited to, identifying a reason behind a discrepancy between subsequent digital twin models such that the discrepancy may be automatically resolved, scheduling an automatic cleaning of target areas of the machine using robots, and preventing unnecessary and costly maintenance on the machine. The present invention does not require that all advantages need to be incorporated into every embodiment of the invention.

According to at least one embodiment, in a multi-machine environment, real-time and historical data may be received from one or more sources in the multi-machine environment, where at least one source may be real-time feeds from a plurality of sensors. Upon receiving the real-time and historical data, a first digital twin model of a machine in the multi-machine environment may be created at a first time based on the real-time feeds from the plurality of sensors at the first time, and a second digital twin model of the machine may be created at a second time based on the real-time feeds from the plurality of sensors at the second time. Then, one or more environmental parameters present in the multi-machine environment at the first time and the second time may be identified based on the real-time and historical data from the one or more sources in order to execute first and second digital twin simulations. The first digital twin simulation of a working procedure of the first digital twin model may be executed in accordance with the one or more environmental parameters and the real-time and historical data from the one or more sources at the first time. The second digital twin simulation of the working procedure of the second digital twin model may be executed in accordance with the one or more environmental parameters and the real-time and historical data from the one or more sources at the second time. Upon executing the first and second digital twin simulations, a discrepancy between the first digital twin model and the second digital twin model may be identified based on the execution of the first digital twin simulation and the second digital twin simulation. According to at least one embodiment, in response to determining the discrepancy is caused by a foreign substance on a target area of the machine, a robotic device may be prompted to remove the foreign substance from the target area of the machine. According to at least one other embodiment, in response to determining the discrepancy is not caused by the foreign substance on the target area of the machine, a change in the working procedure of the machine may be recommended based on the discrepancy.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to identify one or more discrepancies between a first digital twin model of a machine and a second digital twin model of the machine based on the execution of digital twin simulations and, accordingly, prompt a robotic device to remove a foreign substance from a target area of the machine.

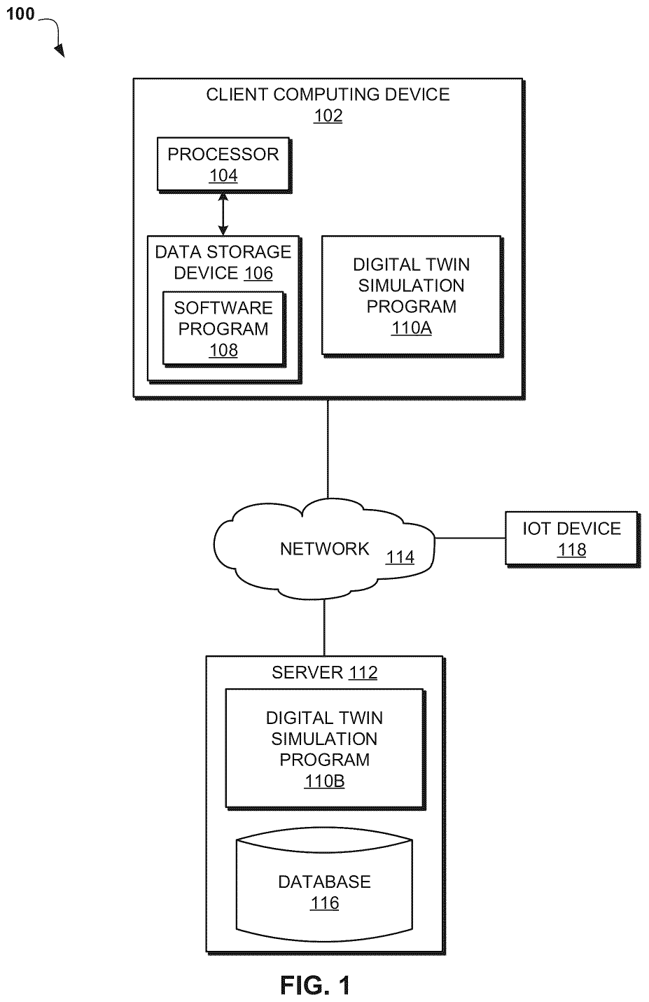

Referring to FIG. 1, an exemplary networked computer environment 100 is depicted, according to at least one embodiment. The networked computer environment 100 may include client computing device 102, a server 112, and Internet of Things (IoT) Device 118 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

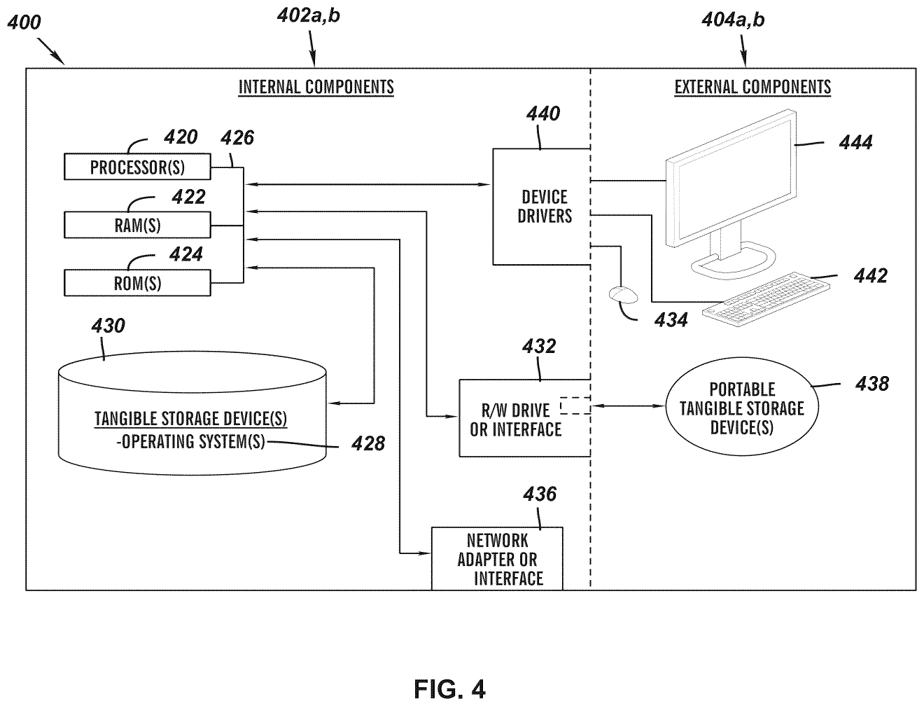

Client computing device 102 may include a processor 104 and a data storage device 106 that is enabled to host and run a software program 108 and a digital twin simulation program 110A and communicate with the server 112 and IoT Device 118 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running a digital twin simulation program 110B and a database 116 and communicating with the client computing device 102 and IoT Device 118 via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

IoT Device 118 may be a machine (e.g., industrial equipment), a plurality of sensors (e.g., motion sensors, temperature sensors, air quality sensors, and/or pressure sensors), a camera, a robotic device, and/or any other automated or manual device known in the art for performing labor related tasks that is capable of connecting to the communication network 114, and transmitting and receiving data with the client computing device 102 and the server 112.

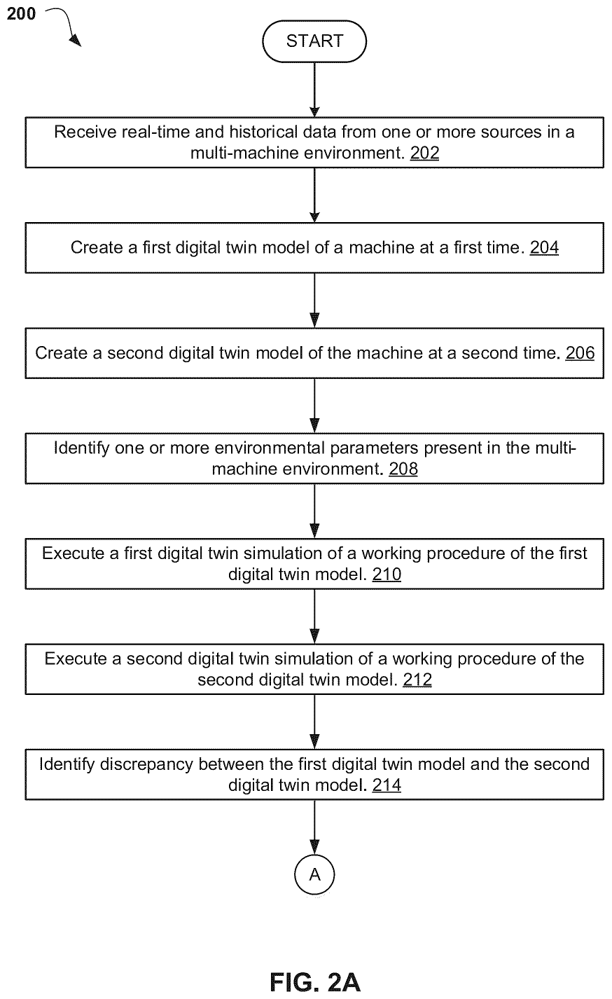

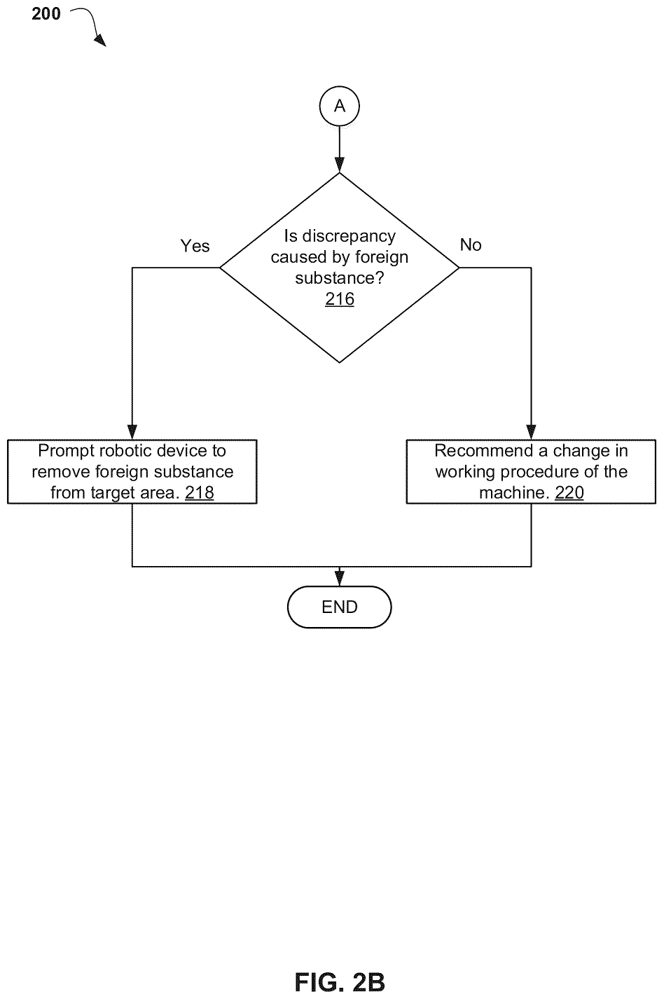

According to the present embodiment, the digital twin simulation program 110A, 110B may be a program capable of receiving real-time and historical data from one or more sources in a multi-machine environment, identifying one or more discrepancies between a first digital twin model of a machine and a second digital twin model of the machine based on the execution of digital twin simulations, prompting a robotic device to remove a foreign substance from a target area of the machine, identifying a reason behind the discrepancy between subsequent digital twin models such that the discrepancy may be automatically resolved, scheduling an automatic cleaning of target areas of the machine using robots, and preventing unnecessary and costly maintenance on the machine. The digital twin simulation method is explained in further detail below with respect to FIGS. 2A and 2B.

Referring now to FIGS. 2A and 2B, an operational flowchart for detecting discrepancies in digital twin simulations in a multi-machine environment in a digital twin discrepancy detection process 200 is depicted according to at least one embodiment. At 202, the digital twin simulation program 110A, 110B receives the real-time and historical data from the one or more sources in the multi-machine environment. Examples of the source may include at least one IoT Device 118 including, but are not limited to, the real-time feeds from the plurality of sensors in the multi-machine environment (e.g., motion sensors, temperature sensors, air quality sensors, and/or pressure sensors), visual inspection feedback from workers in the multi-machine environment, and/or a camera in the multi-machine environment.

The one or more sources may be used by the digital twin simulation program 110A, 110B to generate data about the surrounding environment, such as the presence of foreign substances around the machine and performance of the machine itself. For example, the plurality of sensors may automatically transmit data regarding performance of the machine, such as, for example, oil pressure, internal temperature, flow rate of liquids in the machine, power consumption, revolutions per minute (RPMs) of a motor, and a sound level produced by the machine. In another example, the workers may input this data manually into the digital twin simulation program 110A, 110B via a graphical user interface (GUI). As described above, the data is collected in real-time and historically. The historical data may be input into and retrieved from an artificial intelligence (AI) knowledge corpus and/or a database, such as database 116, described in further detail below with respect to step 216. In this manner, the real-time data becomes the historical data upon being input into the AI knowledge corpus and/or the database 116.

Then, at 204, the digital twin simulation program 110A, 110B creates the first digital twin model of the machine in the multi-machine environment at the first time. The first digital twin model of the machine is created based on the real-time feeds from the plurality of sensors at the first time. For example, the physical machine in the multi-machine environment may be a generator, and the first digital twin model of the generator may be created in accordance with the values received from the plurality of sensors that measure the performance of the generator at the first time. Continuing the example, when the RPMs of the physical generator are 3,000 RPMs and the internal temperature of the physical generator is 150° F. at the first time, the RPMs and internal temperature of the first digital twin model of the generator created at the first time may also be 3,000 RPMs and 150° F., respectively.

According to at least one embodiment, the first time may be a start-up of the machine from a resting position. For example, the machine may have different modes of operation, which may include an active (i.e., operating) mode and a resting mode (i.e., on standby or switched off). In this embodiment, once the machine switches from the resting mode to the active mode, the first digital twin model of the machine may be created. The first time may be recorded as a time of day (e.g., 9:30 a.m.) and/or an elapsed time since the start-up of the machine from the resting position (e.g., five seconds) and stored in the AI knowledge corpus and/or the database 116. According to at least one other embodiment, the first time may be a few minutes (e.g., 5-10 minutes) after the start-up of the machine from the resting position.

Next, at 206, the digital twin simulation program 110A, 110B creates the second digital twin model of the machine at the second time. The second digital twin model of the machine is created based on the real-time feeds from the plurality of sensors at the second time. It may be appreciated that in embodiments of the present invention, the first digital twin model and the second digital twin model are subsequent versions of the same physical machine. Continuing the example above where the physical machine in the multi-machine environment is the generator, the second digital twin model of the generator may be created in accordance with the values received from the plurality of sensors that measure the performance of the generator at the second time. Continuing the example, when the RPMs of the physical generator are 1,000 RPMs and the internal temperature of the physical generator is 350° F. at the second time, the RPMs and internal temperature of the second digital twin model of the generator created at the second time may also be 1,000 RPMs and 350° F., respectively.

According to at least one embodiment, the second time may be a few hours (e.g., 2-5 hours) after the first time. Similar to the first time, the second time may also be recorded as a time of day (e.g., 11:30 a.m.) and/or an elapsed time since the first time (e.g., five hours) and stored in the AI knowledge corpus and/or the database 116. According to at least one other embodiment, the second time may be a few days (e.g., 2-5 days) after the first time when the machine has been operating for more than 24 hours. It may be appreciated that the examples described above are not intended to be limiting, and that in embodiments of the present invention the first digital twin model and the second digital twin model may be created for a variety of different machines at different times. For example, the manager of any multi-machine environment may set the criteria for the first time and the second time.

Then, at 208, the digital twin simulation program 110A, 110B identifies the one or more environmental parameters present in the multi-machine environment at the first time and the second time. The one or more environmental parameters are identified at the first time and the second time based on the real-time and historical data from the one or more sources described above with respect to step 202. Examples of the environmental parameter include, but are not limited to, dust in the multi-machine environment, a liquid (e.g., oil and/or coolant) applied on the machine in the multi-machine environment, and/or a temperature in the multi-machine environment.

According to at least one embodiment, the one or more environmental parameters may be reported in real-time by at least one IoT Device 118, such as the camera or the plurality of sensors themselves and/or manual feedback from the worker. For example, the camera may identify dust and/or oil has accumulated on the machine at the second time, but that there is no dust and/or oil at the first time. In another example, the worker may indicate via the GUI that there is dust and/or oil present on the machine at the second time, but that there is no dust and/or oil at the first time.

According to at least one other embodiment, the one or more environmental parameters may be obtained from the AI knowledge corpus and/or the database 116, such as when the real-time data is unavailable. This historical data may have been reported in the past by the at least one IoT Device 118 and/or the manual feedback from the worker. For example, where the first time is 9:30 a.m., the digital twin simulation program 110A, 110B may query the AI knowledge corpus and/or the database 116 for the environmental parameters typically present at 9:30 a.m. In this example, the historical data may indicate that there is no dust and/or oil in the multi-machine environment at the first time. In another example, where the second time is 11:30 a.m., the digital twin simulation program 110A, 110B may query the AI knowledge corpus and/or the database 116 for the environmental parameters typically present at 11:30 a.m. In this example, the historical data may indicate the dust and/or oil has accumulated on the machine at the second time. It may be appreciated that the examples described above are not intended to be limiting, and that in embodiments of the present invention a variety of environmental paraments may be present or not present at different times.

Next, at 210, the digital twin simulation program 110A, 110B executes the first digital twin simulation of the working procedure of the first digital twin model. The first digital twin simulation is executed in accordance with the one or more environmental parameters and the real-time and historical data from the one or more sources at the first time. The working procedure may be described as how the machine performs the activity, such as the moving parts of the machine to complete the activity. The digital twin simulation program 110A, 110B may have pre-existing knowledge about how the machine performs the activity based on the type of machine. Thus, the working procedure of the machine in the real-world is mirrored by the execution of the first digital twin simulation. Continuing the example above where the first digital twin model is the generator, when the RPMs and internal temperature of the first digital twin model of the generator at the first time are 3,000 RPMs and 150° F., respectively, the first digital twin simulation may be executed with the generator operating at 3,000 RPMs and 150° F. Similarly, when there is no dust and/or oil present in the multi-machine environment at the first time, the first digital twin simulation may be executed without the presence of the dust and/or oil. Additionally, where the temperature at the first time in the multi-machine is 70° F., the first digital twin simulation may be executed with the virtual environment at 70° F.

Then, at 212, the digital twin simulation program 110A, 110B executes the second digital twin simulation of the working procedure of the second digital twin model. The second digital twin simulation is executed in accordance with the one or more environmental parameters and the real-time and historical data from the one or more sources at the second time. Similar to step 210 described above, the working procedure of the machine in the real-world is mirrored by the execution of the second digital twin simulation. Continuing the example above where the second digital twin model is the generator, when the RPMs and internal temperature of the second digital twin model of the generator at the second time are 1,000 RPMs and 350° F., respectively, the second digital twin simulation may be executed with the generator operating at 1,000 RPMs and 350° F. Similarly, when there is dust and/or oil present in the multi-machine environment at the second time, the second digital twin simulation may be executed with the presence of the dust and/or oil on the machine. Additionally, where the temperature at the second time in the multi-machine is 80° F., the second digital twin simulation may be executed with the virtual environment at 80° F. It may be appreciated that the examples described above are not intended to be limiting, and that in embodiments of the present invention the first digital twin simulation and the second digital twin simulation may be executed with different values based on the one or more environmental parameters and the real-time and historical data.

Next, at 214, the digital twin simulation program 110A, 110B identifies the discrepancy between the first digital twin model and the second digital twin model. The discrepancy is identified based on the execution of the first digital twin simulation and the second digital twin simulation. The digital twin simulation program 110A, 110B may perform comparative analysis on each of the first digital twin simulation and the second digital twin simulation. The discrepancy may be a change in a sensor feed value between the first digital twin model and the second digital twin model. Continuing the example described above, when, during the first digital twin simulation, the sensor feeds indicate the RPMs and internal temperature of the first digital twin model of the generator at the first time are 3,000 RPMs and 150° F., respectively, then any value other than 3,000 RPMs and 150° F. in the second digital twin model during the second digital twin simulation may be a discrepancy. For example, when the RPMs and internal temperature of the second digital twin model of the generator at the second time are 1,000 RPMs and 350° F., respectively, there would be multiple discrepancies (i.e., a discrepancy between the values for RPMs and a discrepancy between the values for internal temperature).

Then, at 216, the digital twin simulation program 110A, 110B determines whether the discrepancy is caused by a foreign substance on a target area of the machine. Examples of the foreign substance may include, but are not limited to, dust, oil, fuel, coolant, antifreeze, and/or any other foreign substance known in the art that could impact the feeds from the sensors of the machine. The target area may be one or more locations on the machine where sensors are present. As described above with respect to step 202, the one or more sources may be used by the digital twin simulation program 110A, 110B to generate data about the surrounding environment, such as the presence of foreign substances around the machine and the performance of the machine itself, and the historical data may be input into and retrieved from the artificial intelligence AI knowledge corpus and/or the database 116. When the foreign substance is present in the multi-machine environment, and when a particular sensor feed value reads a certain number during the presence of the foreign substance, the sensor feed value may be associated with the foreign substance by, for example, tagging the sensor feed value with a metadata annotation in the AI knowledge corpus and/or the database 116. Thus, the determination may be made based on correlating the changed sensor feed value in the second digital twin model with the historical value in the AI knowledge corpus and/or the database 116 that is associated with the foreign substance. For example, any time dust is present on the machine in the multi-machine environment, the sensors generating data about RPMs and internal temperature may read 1,000 RPMs and 350° F., respectively. Continuing the example, when the RPMs and internal temperature of the second digital twin model of the generator at the second time are 1,000 RPMs and 350° F., respectively, the historical value and the value in the second digital twin model match and the digital twin simulation program 110A, 110B may determine the discrepancy between the first digital twin model and the second digital twin model is caused by the foreign substance (e.g., due to the fact that when dust covers the sensor, the sensor cannot transmit an accurate reading). It may be appreciated that the examples described above are not intended to be limiting, and that in embodiments of the present invention the presence of the foreign substance may result in a variety of different values from the sensors.

In response to determining the discrepancy is caused by the foreign substance on the target area of the machine (step 216, “Yes” branch), the digital twin discrepancy detection process 200 proceeds to step 218 to prompt the robotic device to remove the foreign substance from the target area of the machine. In response to determining the discrepancy is not caused by the foreign substance on the target area of the machine (step 216, “No” branch), the digital twin discrepancy detection process 200 proceeds to step 220 to recommend the change in the working procedure of the machine based on the discrepancy.

Next, at 218, the digital twin simulation program 110A, 110B prompts the robotic device to remove the foreign substance from the target area of the machine. Upon determining the discrepancy is caused by the foreign substance on the target area of the machine, the digital twin simulation program 110A, 110B may send a signal to the robotic device to remove the foreign substance from the target area. The foreign substance may be removed by cleaning the foreign substance off the target area. The prompt to remove the foreign substance may identify a type of cleaning that is required to remove the foreign substance. Examples of the type of cleaning that is required may include, but are not limited to, blowing the foreign substance off the target area, scrubbing the foreign substance off the target area, and/or dusting the foreign substance off the target area. For example, when the foreign substance is dust covering one of the sensors on the machine, the type of cleaning may include blowing and/or dusting. In another example, when the foreign substance is oil covering one of the sensors on the machine, the type of cleaning may include scrubbing the target area with soap and water. According to at least one embodiment, based on the historical pattern of the foreign substance on the target area of the machine, the robotic device may be prompted to clean the target areas periodically throughout the day.

Then, at 220, the digital twin simulation program 110A, 110B recommends the change in the working procedure of the machine. The recommendation is based on the discrepancy. When the discrepancy between the first digital twin model and the second digital twin model is not caused by the foreign substance on the target area of the machine, it may be inferred that the discrepancy is due to an actual problem with the machine, such as the machine is malfunctioning. For example, when the first digital twin model has an internal temperature of 150° F. and the second digital twin model has an internal temperature of 350° F., the discrepancy may be due to the machine overheating. In this example, the recommended change in the working procedure may be to keep the machine in the resting position for a longer period of time and/or replace the coolant more frequently.

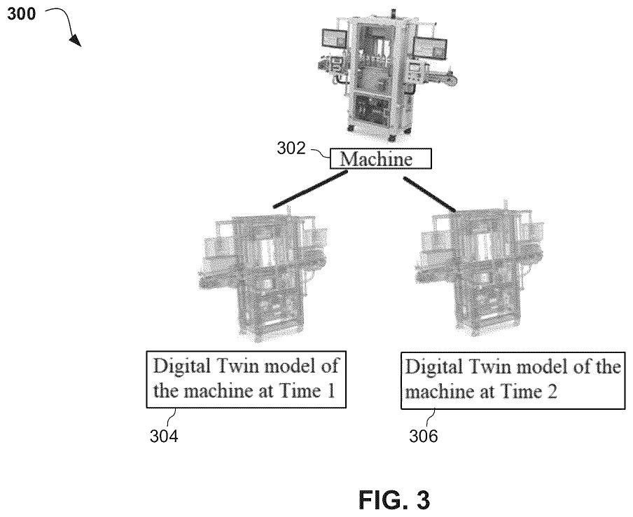

Referring now to FIG. 3, an exemplary diagram 300 depicting a physical machine 302 and digital twin models 304, 306 of the physical machine 302 at different times is shown according to at least one embodiment. In the diagram 300, the physical machine 302 may be performing tasks in a working environment in accordance with a working procedure. The physical machine may also be equipped with the plurality of sensors which transmit data relating to the performance of the physical machine 302. Based on the data transmitted by these sensors, the first digital twin model at the first time 304 and the second digital twin model at the second time 306 may be created. The first digital twin model at the first time 304 and the second digital twin model at the second time 306 may be used to conduct the first and second digital twin simulations, respectively, to identify the discrepancy as described above with respect to the description of FIGS. 2A and 2B.

It may be appreciated that FIGS. 2A, 2B, and 3 provide only an illustration of one implementation and do not imply any limitations with regard to how different embodiments may be implemented. Many modifications to the depicted environments may be made based on design and implementation requirements.

FIG. 4 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402a,b and external components 404a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the digital twin simulation program 110A in the client computing device 102 and the digital twin simulation program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402a,b also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the digital twin simulation program 110A, 110B, can be stored on one or more of the respective portable computer-readable tangible storage devices 438, read via the respective R/W drive or interface 432, and loaded into the respective hard drive 430.

Each set of internal components 402a,b also includes network adapters or interfaces 436 such as a TCP/IP adapter cards, wireless Wi-Fi interface cards, or 3G or 4G wireless interface cards or other wired or wireless communication links. The software program 108 and the digital twin simulation program 110A in the client computing device 102 and the digital twin simulation program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the digital twin simulation program 110A in the client computing device 102 and the digital twin simulation program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404a,b can also include touch screens, virtual keyboards, touch pads, pointing devices, and other human interface devices. Each of the sets of internal components 402a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

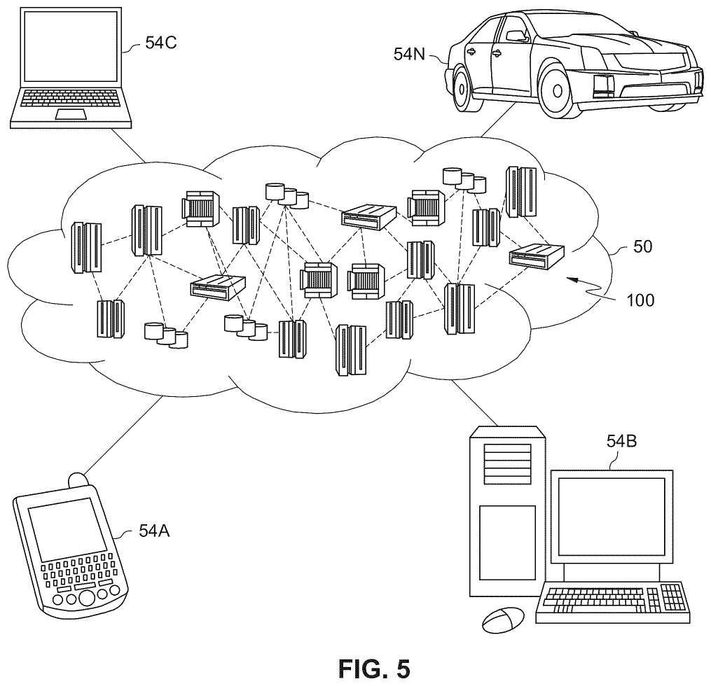

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

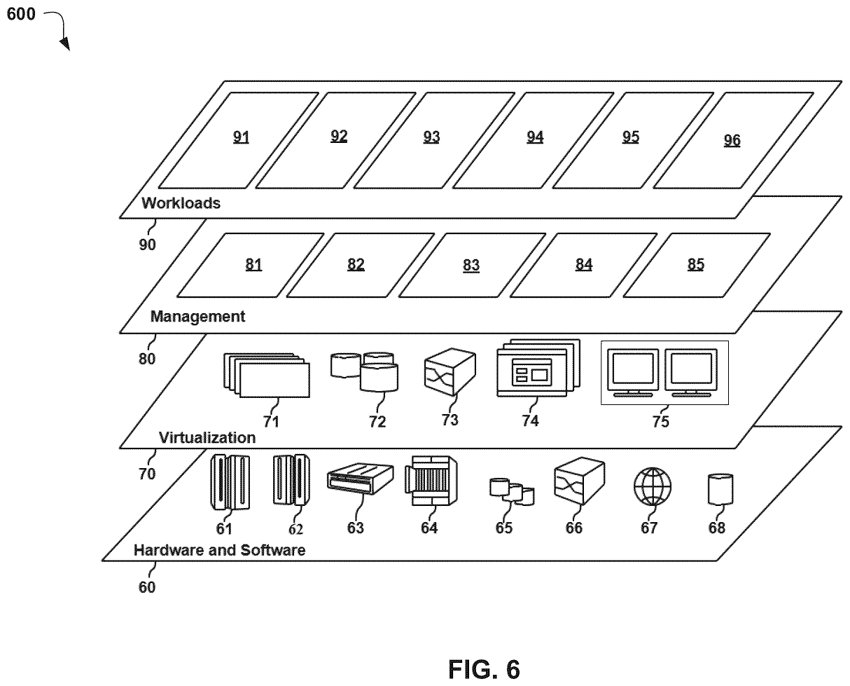

Referring now to FIG. 6, a set of functional abstraction layers 600 provided by cloud computing environment 50 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and detecting discrepancies in digital twin simulations in a multi-machine environment 96. Detecting discrepancies in digital twin simulations in a multi-machine environment 96 may relate to identifying one or more discrepancies between a first digital twin model of a machine and a second digital twin model of the machine based on the execution of digital twin simulations in order to prompt a robotic device to remove a foreign substance from a target area of the machine.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of detecting discrepancies in digital twin simulations in a multi-machine environment, the method comprising:
receiving real-time and historical data from one or more sources in a multi-machine environment, wherein at least one source is real-time feeds from a plurality of sensors in the multi-machine environment;
creating a first digital twin model of a machine in the multi-machine environment at a first time based on the real-time feeds from the plurality of sensors at the first time;
creating a second digital twin model of the machine in the multi-machine environment at a second time based on the real-time feeds from the plurality of sensors at the second time;
identifying one or more environmental parameters present in the multi-machine environment at the first time and the second time based on the real-time and historical data from the one or more sources;
executing a first digital twin simulation of a working procedure of the first digital twin model in accordance with the one or more environmental parameters and the real-time and historical data from the one or more sources at the first time;
executing a second digital twin simulation of the working procedure of the second digital twin model in accordance with the one or more environmental parameters and the real-time and historical data from the one or more sources at the second time;
identifying a discrepancy between the first digital twin model and the second digital twin model based on the execution of the first digital twin simulation and the second digital twin simulation;
determining whether the discrepancy is caused by a foreign substance on a target area of the machine; and
in response to determining the discrepancy is caused by the foreign substance on the target area of the machine, prompting a robotic device to remove the foreign substance from the target area of the machine.

2. The computer-based method of claim 1, further comprising:
in response to determining the discrepancy is not caused by the foreign substance on the target area of the machine, recommending a change in the working procedure of the machine based on the discrepancy.

3. The computer-based method of claim 1, wherein prompting the robotic device to remove the foreign substance from the target area of the machine further comprises:
identifying a type of cleaning that is required to remove the foreign substance.

4. The computer-based method of claim 1, wherein the discrepancy is a change in a sensor feed value between the first digital twin model and the second digital twin model.

5. The computer-based method of claim 4, wherein the determination that the discrepancy is caused by the foreign substance on the target area of the machine is made based on correlating the changed sensor feed value in the second digital twin model with a historical value in a knowledge corpus that is associated with the foreign substance.

6. The computer-based method of claim 1, wherein the first time is a start-up of the machine from a resting position.

7. The computer-based method of claim 1, wherein the environmental parameter is selected from a group consisting of dust in the multi-machine environment, a liquid applied on the machine in the multi-machine environment, and an air temperature in the multi-machine environment.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving real-time and historical data from one or more sources in a multi-machine environment, wherein at least one source is real-time feeds from a plurality of sensors in the multi-machine environment;
creating a first digital twin model of a machine in the multi-machine environment at a first time based on the real-time feeds from the plurality of sensors at the first time;
creating a second digital twin model of the machine in the multi-machine environment at a second time based on the real-time feeds from the plurality of sensors at the second time;
identifying one or more environmental parameters present in the multi-machine environment at the first time and the second time based on the real-time and historical data from the one or more sources;
executing a first digital twin simulation of a working procedure of the first digital twin model in accordance with the one or more environmental parameters and the real-time and historical data from the one or more sources at the first time;
executing a second digital twin simulation of the working procedure of the second digital twin model in accordance with the one or more environmental parameters and the real-time and historical data from the one or more sources at the second time;
identifying a discrepancy between the first digital twin model and the second digital twin model based on the execution of the first digital twin simulation and the second digital twin simulation;
determining whether the discrepancy is caused by a foreign substance on a target area of the machine; and
in response to determining the discrepancy is caused by the foreign substance on the target area of the machine, prompting a robotic device to remove the foreign substance from the target area of the machine.

9. The computer system of claim 8, further comprising:
in response to determining the discrepancy is not caused by the foreign substance on the target area of the machine, recommending a change in the working procedure of the machine based on the discrepancy.

10. The computer system of claim 8, wherein prompting the robotic device to remove the foreign substance from the target area of the machine further comprises:
identifying a type of cleaning that is required to remove the foreign substance.

11. The computer system of claim 8, wherein the discrepancy is a change in a sensor feed value between the first digital twin model and the second digital twin model.

12. The computer system of claim 11, wherein the determination that the discrepancy is caused by the foreign substance on the target area of the machine is made based on correlating the changed sensor feed value in the second digital twin model with a historical value in a knowledge corpus that is associated with the foreign substance.

13. The computer system of claim 8, wherein the first time is a start-up of the machine from a resting position.

14. The computer system of claim 8, wherein the environmental parameter is selected from a group consisting of dust in the multi-machine environment, a liquid applied on the machine in the multi-machine environment, and an air temperature in the multi-machine environment.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving real-time and historical data from one or more sources in a multi-machine environment, wherein at least one source is real-time feeds from a plurality of sensors in the multi-machine environment; creating a first digital twin model of a machine in the multi-machine environment at a first time based on the real-time feeds from the plurality of sensors at the first time;
creating a second digital twin model of the machine in the multi-machine environment at a second time based on the real-time feeds from the plurality of sensors at the second time;
identifying one or more environmental parameters present in the multi-machine environment at the first time and the second time based on the real-time and historical data from the one or more sources;
executing a first digital twin simulation of a working procedure of the first digital twin model in accordance with the one or more environmental parameters and the real-time and historical data from the one or more sources at the first time;
executing a second digital twin simulation of the working procedure of the second digital twin model in accordance with the one or more environmental parameters and the real-time and historical data from the one or more sources at the second time;
identifying a discrepancy between the first digital twin model and the second digital twin model based on the execution of the first digital twin simulation and the second digital twin simulation;
determining whether the discrepancy is caused by a foreign substance on a target area of the machine; and
in response to determining the discrepancy is caused by the foreign substance on the target area of the machine, prompting a robotic device to remove the foreign substance from the target area of the machine.

16. The computer program product of claim 15, further comprising:
in response to determining the discrepancy is not caused by the foreign substance on the target area of the machine, recommending a change in the working procedure of the machine based on the discrepancy.

17. The computer program product of claim 15, wherein prompting the robotic device to remove the foreign substance from the target area of the machine further comprises:
identifying a type of cleaning that is required to remove the foreign substance.

18. The computer program product of claim 15, wherein the discrepancy is a change in a sensor feed value between the first digital twin model and the second digital twin model.

19. The computer program product of claim 18, wherein the determination that the discrepancy is caused by the foreign substance on the target area of the machine is made based on correlating the changed sensor feed value in the second digital twin model with a historical value in a knowledge corpus that is associated with the foreign substance.

20. The computer program product of claim 15, wherein the first time is a start-up of the machine from a resting position.
